(19) United States
(12) Patent Application Publication
(10) Pub. No.: US 2013/0322083 A1
(43) Pub. Date: Dec. 5, 2013

(54) Poseable Illumination Device Having Multiple Illumination Sources

(71) Applicant: Ryan Toaspern, Paia, HI (US)

(72) Inventor: Ryan Toaspern, Paia, HI (US)

(21) Appl. No.: 13/483,681

(22) Filed: May 30, 2012

(51) Int. Cl. F21S 4/00

(52) U.S. Cl. 362/249.05; 362/249.12

(57) ABSTRACT

An illumination device includes a plurality of independently poseable arms. Each independently poseable arm has a first end and a second end and the first end is electrically connected to the second end. The illumination device also includes a plurality of light modules, each light module being coupled and electrically connected to the first end of one of the plurality of independently poseable arms. The illumination device includes a housing coupled to the second end of each of the plurality of arms is connected to the housing and configured to receive a battery, and a switch configured to selectively control electrical connections between the second end of each of the plurality of arms and the battery such that the plurality of light modules operate in unison.

### BACKGROUND OF THE INVENTION

This application relates to an illumination device that allows for focused illumination of a localized area. Further, the illumination device provides a versatile means of attaching or fixing the illumination device on a user or object.

The need for a flexible, focused illumination device arises in a variety of situations. When working in a confined space such as an engine compartment, it can be difficult to effectively illuminate one's workspace. Using a conventional headlamp, such as the Petzl Tikka® provides a wide swath of light that may be blocked by structures within the confined space—including the user's own hands and tools. While a conventional flashlight, such as a MAGLITE® may allow a user to direct light to the desired location, it requires that the user hold the flashlight in place—usually with a hand that becomes unavailable to complete the task at issue. Further, when working in confined spaces, illuminating from a single direction that has sufficient space for a conventional flashlight may cause the desired work area to be shadowed. Still further, in some situations, the only way to illuminate an area requires that light be directed around a corner.

Even when working at a desk or workbench, it is beneficial to properly position a light source to effectively illuminate the desired work area. However, with a single light source having minimal adjustability, such as a conventional desk lamp or work lamp, it, can be difficult to direct light in the desired manner and eliminate shadows or provide sufficient illumination to a desired area.

### SUMMARY OF THE INVENTION

The present invention provides for an illumination device having that has multiple sources of illumination, each of which is located at the end of a poseable arm that is connected to a single housing. Each of the poseable arms is bendable and flexible, and each arm retains its shape when positioned or adjusted by a user. Thus, in accordance with the invention, an illumination device is provided having:

(a) a plurality of independently poseable arms, wherein each arm has a first end and a second end and the first end is electrically connected to the second end;

(b) a plurality of light modules, each light module being coupled and electrically connected to the first end of one of the plurality of independently poseable arms;

(c) a housing coupled to the second end of each of the plurality of arms is connected to the housing and configured to receive a battery; and

(d) a switch configured to control electrical connections between the second end of each of the plurality of arms and the battery such that the plurality of light modules operate in unison.

In some embodiments, each of the light modules is detachably coupled to the first end of one of the plurality of independently poseable arms. In some embodiments, each independently poseable arm is detachably coupled to the housing. In still other embodiments, one or more of the independently poseable arms may also be illuminated by one or more auxiliary light modules disposed along its length, between the first and second ends. The one or more auxiliary light modules may be slidably mounted and/or rotatably mounted.

### BRIEF DESCRIPTION OF THE DRAWINGS

FIG. 1 shows a side view of an illumination device in accordance with the present invention.

FIG. 2 shows an enlarged cross-section view of an independently poseable arm of an illumination device in accordance with the present invention.

FIG. 3 shows a side view of a distal end of an independently poseable arm of an illumination device in accordance with the present invention.

FIG. 4 shows a side view of an illumination device in accordance with the present invention.

FIG. 5 shows a side view of an illumination device with a table stand in accordance with the present invention.

FIG. 6 shows a side view of an illumination device in a charger in accordance with the present invention.

FIGS. 7A and 7B show bottom views of the housing of an illumination device in accordance with the present invention, configured for charging.

FIG. 8 shows a top view of a housing of an illumination device and a side view of an end of an independently poseable arm in accordance with the present invention.

FIG. 9 shows a top view of a housing of an illumination device and a side view of an end of an independently poseable arm in accordance with the present invention.

### DETAILED DESCRIPTION

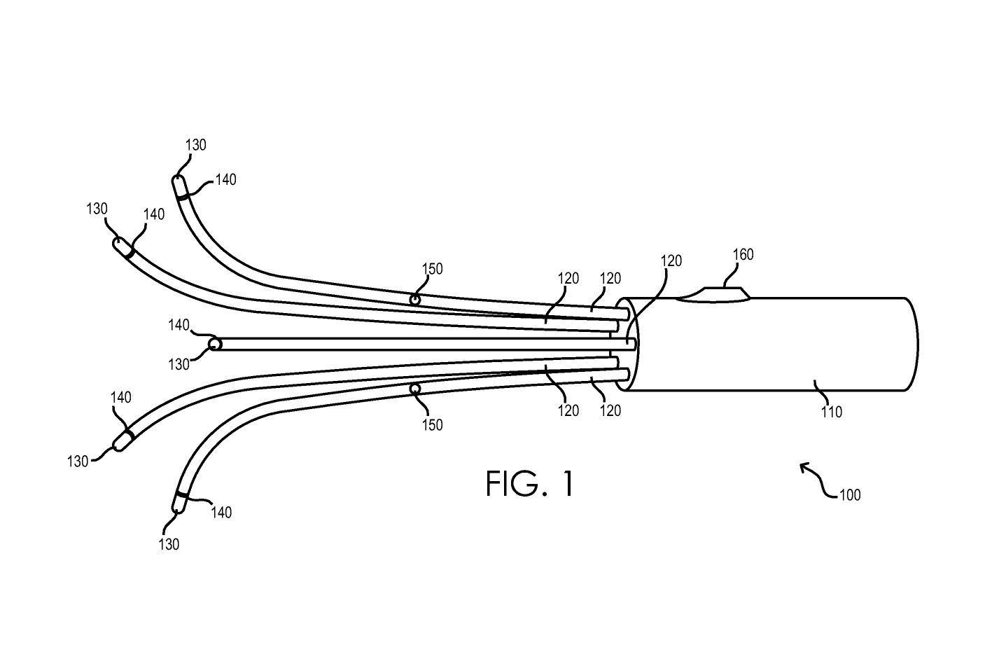

FIG. 1 shows a side view of an illumination device in accordance with the present invention. The illumination device comprises a housing 110 and a plurality of poseable arms 120 which are coupled to the housing at a proximal end. While the housing illustrated in FIG. 1 is substantially cylindrical, the housing may be of any shape. Preferably, the housing is shaped to be ergonomic and easily and comfortably grasped by a user. Poseable arms 120 are each independently moveable by a user, are both bendable and flexible so that the arms are positionable by a user, and each poseable arm retains its shape when positioned by a user.

Light modules 130 are disposed at the distal ends of each of the poseable arms 120, opposite housing 110. Each light module contains a light source. The light source may be, for example, a solid state light source such as a light-emitting diode. Alternatively, the light source may be halogen light bulb, or incandescent light bulb. Optionally, other components necessary to make the light source operate at a specific operating voltage, such as resistors, may also be contained within the light module, or contained within the housing 110. A cover may also be affixed to the light source, allowing a user to alter the color of the light module, vary the diffusion of the light module, and/or provide directionality and/or focus to the light source. For example, a cover may have a colored lens and be configured with a rotatably adjustable diaphragm that allows a user to adjust the size of the light beam emitted from the light module.

Each light module 130 is each electrically connected the poseable arm 120 on which it is disposed. Connectors 140 provide for a detachable coupling between each light module 130 and the poseable arm 120 to which the light module is connected. This facilitates user-replacement of the light module in the event that the light module is damaged or that the light module fails for any reason. In another implementation, light modules may be permanently mounted at the distal ends of their respective poseable arms.

Each of the poseable arms 120 serves provides an electrical connection between housing 110 and the light module 130 disposed at the end of the poseable arm. In one implementation, each poseable arm is constructed of an electrically conductive core encased in a bendable, flexible insulator, and the poseable properties of the arm result from the electrically conductive core. In another implementation, the electrically conductive core is clad in a bendable, flexible insulating layer that retains its shape when positioned, thus the poseable properties of the arm result from the insulating layer. In yet another implementation, an electrically conductive core and insulating layer are surrounded by a plastic or metal housing, such as a woven or corrugated tubing, that provides for retention of user-defined positioning. In still another implementation, each poseable arm may be formed from modular tubing or hose that provides for poseability of the arm, and has an electrically conductive core. In each of these implementations, the electrically conductive core is configured to provide electrical communication between the light module located at the distal end of each poseable arm and the housing when the poseable arm is communicably coupled to the housing.

The illumination device optionally includes one or more auxiliary light modules 150. Each auxiliary light module contains a light source, such as a light-emitting diode, halogen light bulb, or incandescent light bulb. Optionally, other components necessary to make the light source operate at a specific operating voltage, such as resistors, may also be contained within the light module. Optional components may also be contained within the housing 110. Auxiliary light modules 150 provide for ambient light, rather than the directional light provided by light modules 130. Auxiliary light modules 150 are optionally located along the length of one or more of the poseable arms 120. Each of the auxiliary light modules 150 is configured for electrical communication with the housing 110 via the electrically conductive core of the poseable arm on which it is mounted.

Switch assembly 160 is integrated with housing 110, and provides for a controllable electrical connection between the poseable arms and a power supply (not illustrated) within the housing 110. Switch assembly 160 is configured to operate the light modules 130 as a single unit. In one implementation, auxiliary light modules 150 are operated via switch assembly 160 such that optional auxiliary light modules 150 are operated in unison with light modules 130. In another implementation, switch assembly 160 is a multi-position switch which serves to selectively operate light modules 130 as a single unit; optional auxiliary light modules 150 as a single unit; or light modules 130 and optional auxiliary light modules 150 as a single unit.

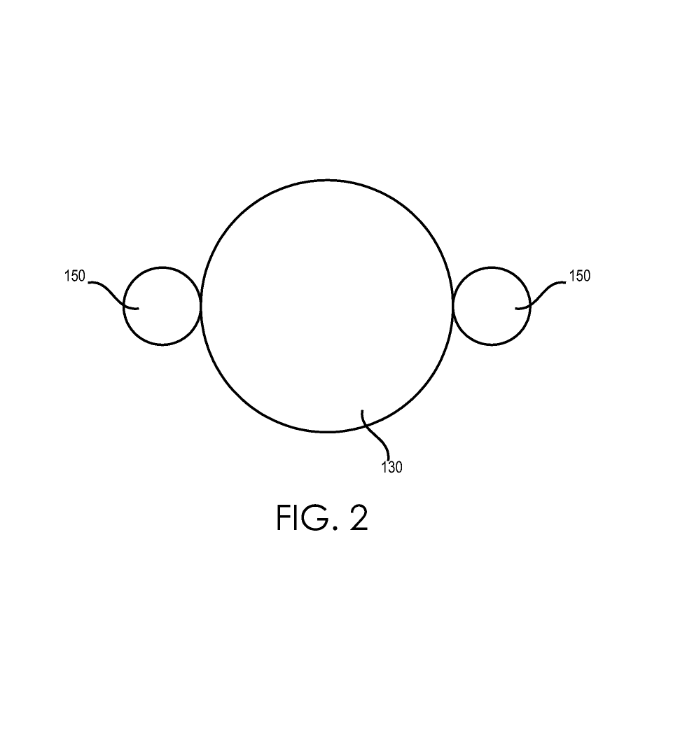

FIG. 2 shows an enlarged cross-section view of an independently poseable arm of an illumination device in accordance with the present invention. Light module 130, located at the distal end of a poseable arm (not shown) is flanked by two optional auxiliary light modules 150. Light module 130 and the auxiliary light modules 150 are in electrical communication with the poseable arm. In an implementation, the auxiliary light modules are fixed to the poseable arm. In another implementation, the auxiliary light modules are slidably mounted on the poseable arm, such that a user can adjust the position of the auxiliary light modules along the length of the poseable arm, between the proximal end and the distal end of the poseable arm. In still another implementation, the auxiliary light modules are rotatably mounted on the poseable arm, such that the position of the auxiliary light modules is adjustable along the circumference or outer edge of the poseable arm. Optionally, the auxiliary light modules may be detachably coupled to the poseable arm so that a user can add or remove auxiliary light modules based on the need for light from the illumination device. In a non-limiting example, auxiliary light modules may be removed to conserve power.

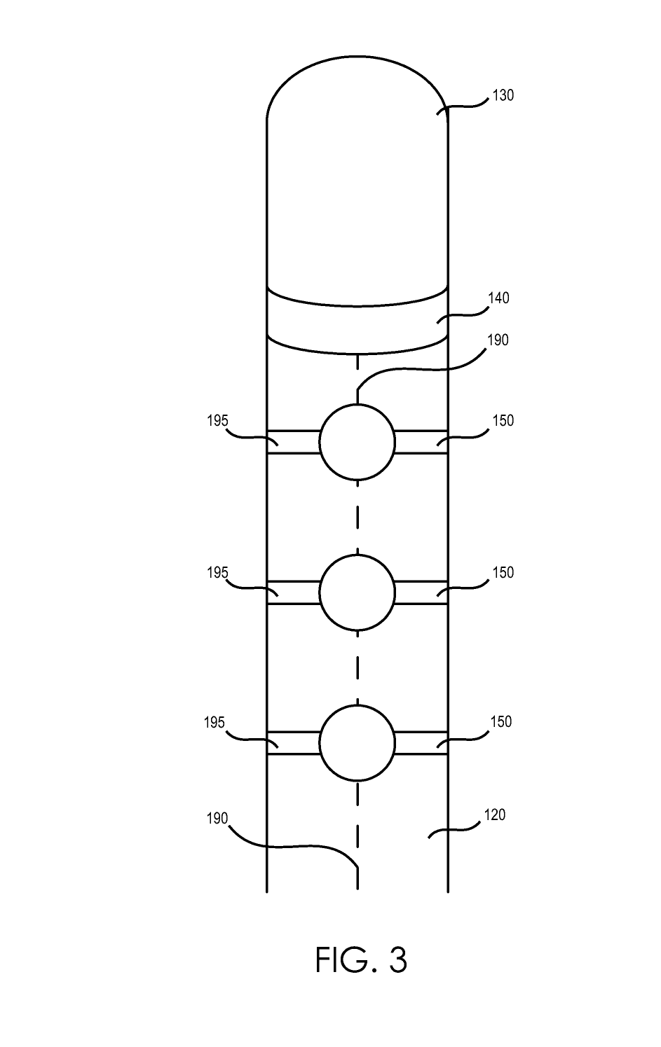

FIG. 3 shows a side view of a distal end of an independently poseable arm of an illumination device in accordance with the present invention. While light module 130 is illustrated with a dome-shaped covering, it should be appreciated that light module 130 may have any shape and, further, may be configured with an aperture to provide additional user-adjustable focus to the light emitted from the light module 130. Further, the light module 130 may be enclosed by a colored light module housing. Coupling 140 provides for a user-detachable coupling between the light module 130 and the poseable arm 120. In an implementation, the coupling 140 may be permanently affixed to the distal end of poseable arm 120, and detachably coupled to light module 130. In another implementation, the coupling may be permanently fixed to the light source 130 and detachable coupled to the poseable arm by threading or the like. In still another implementation, the coupling may be detachably coupled to both the light source and the poseable arm.

Auxiliary light sources 150 are shown at three different, user-adjustable positions along the length of poseable arm 120. Preferably, each poseable arm is 12 to 14 inches long, but may be of any length. Further the poseable arms may be of varying lengths. Each auxiliary light source 150 is held in place via a band 195. In an implementation, each band 195 has resilient elastic properties that allow the band to be repeatedly repositioned along the length of a poseable arm. Trace 190 extends along the length of poseable arm 120 and provides for an electrical connection between the auxiliary light sources and the poseable arm. Thus, one or more auxiliary light modules 150 may be user configured and adjustable along the length of each poseable arm. In another implementation, one or more auxiliary light sources is fixed along the poseable arm by a clamp.

In still another implementation, an independently poseable arm is covered in a self-healing, electrically insulative material. The auxiliary light source is configured to penetrate this self-healing, electrically insulative material and create an electrical connection between the electrically conductive core of the independently poseable arm and the auxiliary light source. The auxiliary light source may then be fixed in place by an external fixation device, such as a clamp or resilient elastic band. The self-healing properties of the covering of the independently poseable arm allow one or more auxiliary light sources to be repeatedly placed along and removed from any position along the independently poseable arm.

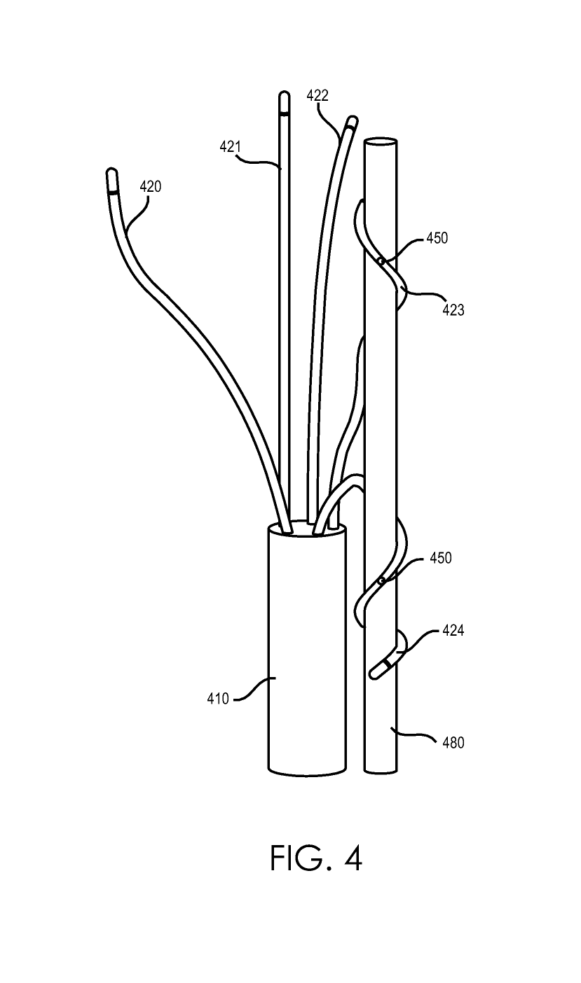

FIG. 4 shows a side view of an illumination device in accordance with the present invention. In FIG. 4, the illumination device is configured for hands free operation by wrapping poseable arms 423 and 424 around an object 480. Poseable arms 420, 421, and 422 may be positioned in any configuration by a user. Auxiliary light modules 450 are positioned to provide ambient light in a direction desired by the user, and are detachably mounted and user-configurable.

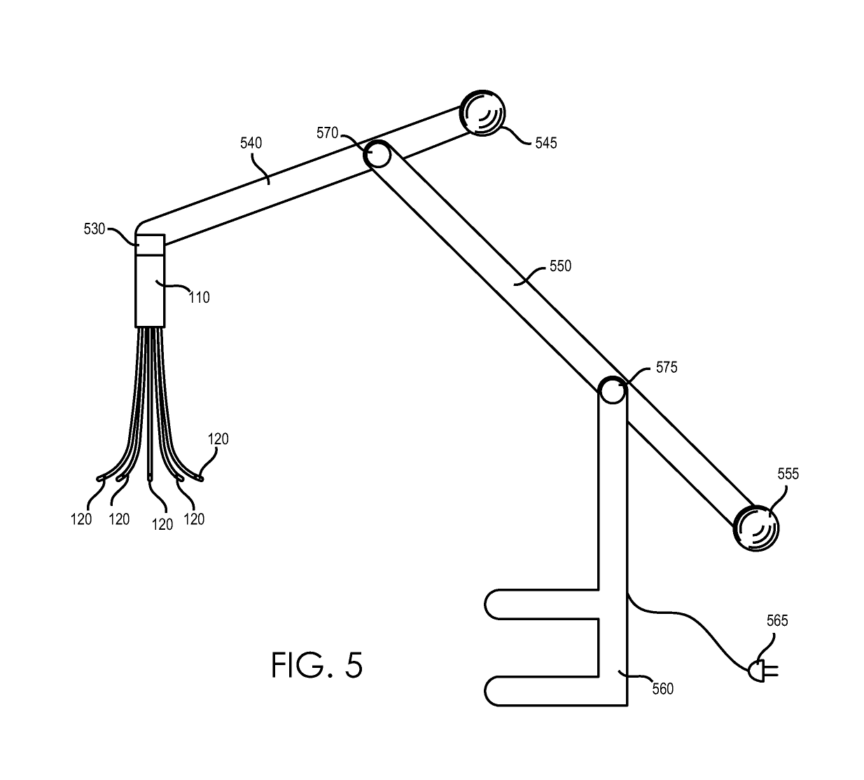

FIG. 5 shows a side view of an illumination device with a table stand in accordance with the present invention. Illumination device 100 in accordance with the present invention comprises housing 110 and a plurality of poseable arm 120, each poseable arm having a light module (not shown) at its distal end. Adjustable clamp 530 allows for a user to detachably affix the portable illumination device to a structure that provides for additional adjustability of the lamp when working, for example, at a desk. The structure is fixed to a table or desk via claim 560. Arm 550 is configured to pivot and/or rotate at joint 575. Weight 555 balances the weight of arm 550. Arm 540 is connected to adjustable claim 530. This connection may be pivotable and/or rotatable, or fixed. Arm 540 and arm 550 are connected at joint 570, which may be pivotable and/or rotatable. The weight of arm 540 and illumination device 100 is balanced by weight 545. Optional electrical connector 565 provides for the table stand to connect to an external power source, and is in electrical communication with clamp 530 to provide for recharging the power supply contained within portable illumination device 100.

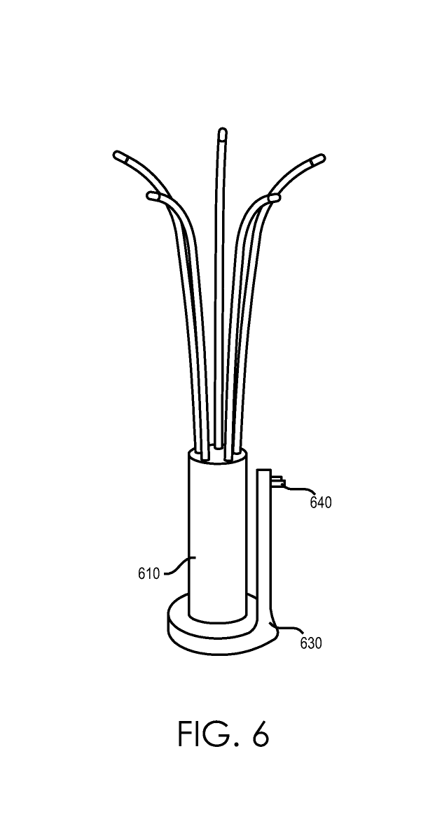

FIG. 6 shows a side view of an illumination device in a charger in accordance with the present invention. Specifically, portable illumination device 610 is illustrated positioned for charging in a charger 630, which is connectable to a conventional household outlet via electrical connectors 640.

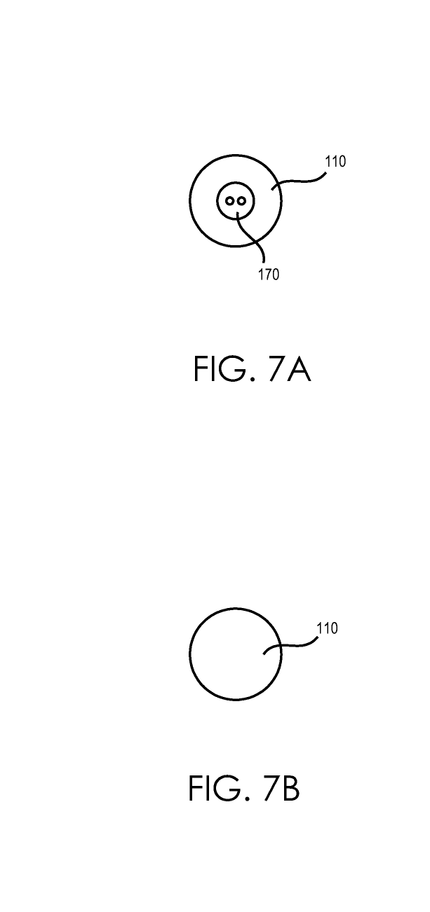

FIGS. 7A and 7B show bottom views of the housing of an illumination device in accordance with the present invention. In FIG. 7a, electrical connectors 170 are disposed on the bottom of housing 110 so that the power supply can be charged via a charger, such as that illustrated in 630. Thus, a power supply such as a rechargeable battery can be charged without removing the power supply from the housing. In an alternative embodiment, as shown in FIG. 7b, the bottom of the housing may be free of external electrical connectors, and the power supply (not shown) configured to charge via inductive charging. In another implementation, the bottom of housing 110 is threaded to facilitate access to a user-replaceable power supply, such as one or more disposable batteries.

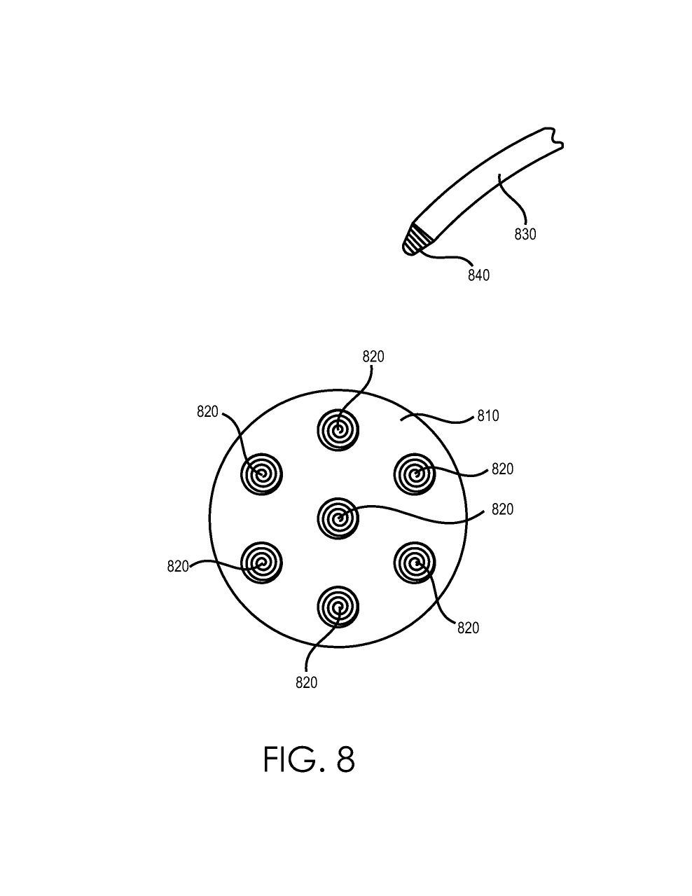

FIG. 8 shows a top view of a housing of an illumination device and a side view of an end of an independently poseable arm in accordance with the present invention. In FIG. 8, housing 810 includes a plurality of threaded connectors 820. Each threaded connector is configured to receive a threaded connector 840 at the proximal end of a poseable arm 830. Each threaded connector 820 is configured to provide an electrical connection between the proximal end of a poseable arm 830 and a power supply (not shown) that is controlled via a switch (not shown) when threaded connector 820 is mated with threaded connector 840. It should be appreciated that a user may choose to use all of the threaded connectors available at the top of the housing, or only a portion of those connectors. Further, it should be understood that a user can choose the arrangement of poseable arms connected with the housing, and replace one or more poseable arms should one or more poseable arms become unoperable.

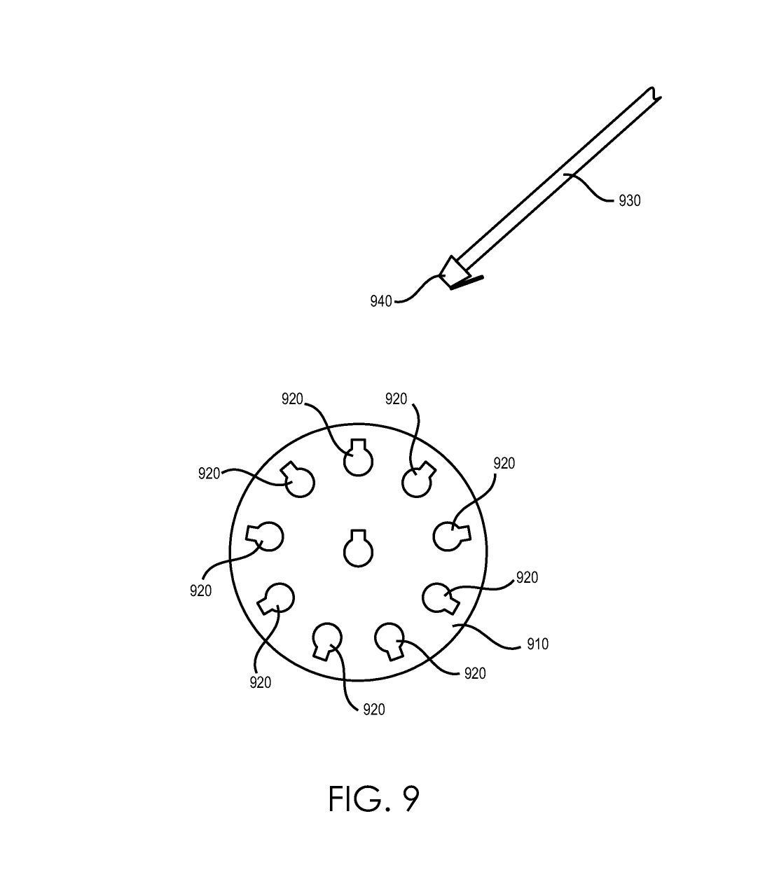

FIG. 9 shows a top view of a housing of an illumination device and a side view of an end of an independently poseable arm in accordance with the present invention. FIG. 9 shows a top view of a housing of an illumination device and a side view of an end of an independently poseable arm in accordance with the present invention. In FIG. 9, housing 910 includes a plurality of ports 920 configured to receive a module connector 940 disposed at the proximal end of a poseable arm 930. Each port 920 is configured to provide an electrical connection between the proximal end of a poseable arm 930 and a power supply (not shown) that is controlled via a switch (not shown) when port 920 is mated with modular connector 940. Once modular connector 940 is received in a port 920, it is held in place via a deformable tab, and modular connector 940 is releasable from port 920 when that tab is deformed. It should be appreciated that a user may choose to use all of the ports available at the top of the housing, or only a portion of those ports. Further, it should be understood that a user can choose the arrangement of poseable arms connected with the housing, and replace one or more poseable arms should one or more poseable arms become inoperable.

While the foregoing describes a preferred embodiment of the invention, variations can be made without departing from the scope of the invention. For example, the housing may be constructed of any material or materials so long as they user is electrically insulated from the power supply or battery. Further, while many of the embodiments described herein include five poseable arms, the number of poseable arms may range from two poseable arms to ten or more poseable arms, depending on the desired size of the device and the capacity of the power source housed in the housing.

1. An illumination device, comprising:
a plurality of independently poseable arms, wherein each arm has a first end and a second end and the first end is electrically connected to the second end;
a plurality of light modules, each light module being coupled and electrically connected to the first end of one of the plurality of independently poseable arms;
a housing coupled to the second end of each of the plurality of arms is connected to the housing and configured to receive a battery; and
a switch configured to selectively control electrical connections between the second end of each of the plurality of arms and the battery such that the plurality of light modules operate in unison.

2. The illumination device of claim 1, wherein each light module is detachably coupled to the first end of one of the plurality of independently poseable arms.

3. The illumination device of claim 1, wherein each independently poseable arm is detachably coupled to the housing.

4. The illumination device of claim 1, wherein each light module includes a light emitting diode.

5. The illumination device of claim 1, wherein an auxiliary light module is disposed between the first end and the second end of at least one independently poseable arm and electrically connected to the switch via the at least one independently poseable arm.

6. The illumination device of claim 5, wherein the auxiliary light module is permanently mounted on the at least one independently poseable arm.

7. The illumination device of claim 5, wherein the auxiliary light module is configured to be slidably mounted between the first end and the second end of the at least one independently arm.

8. The illumination device of claim 5, wherein the auxiliary light module is configured to be rotatably mounted between the first end and the second end of the at least one independently poseable arm.

9. The illumination device of claim 5, wherein the auxiliary light module is detachably mounted between the first end and the second end of the at least one independently poseable arm.

10. The illumination device of claim 5, wherein the outer covering of the at least one independently poseable arm is a self-healing material, and the auxiliary light module is configured to be detachably mounted between the first and the second end of the at least one independently poseable arm.

11. The illumination device of claim 5, wherein the switch is configured to operate the auxiliary light module in unison with the plurality of light modules.

12. The illumination device of claim 5, wherein the switch is further configured to selectively operate the auxiliary light module or the plurality of light modules in unison with the auxiliary light module.

13. An illumination device, comprising:
a housing configured to receive a power source;
a plurality of independently poseable arms detachably coupled to the housing, each independently poseable arm comprising:
a first end and a second end configured to be in electrical communication, and the second end being coupled to the housing, and
a light module mounted to the first end and configured to be in electrical communication with the second end; and
a switch located on the housing and configured to provide a selective electrical connection between the power source and the second end of each of the plurality of independently poseable arms.

14. An illumination device according to claim 13, wherein the plurality of independently poseable arms are detachably coupled to the housing by modular connectors.

15. An illumination device according to claim 14, wherein each of the plurality of independently poseable arms includes an electrically conductive core configured to provide electrical communication between the first end and the second end, and the electrically conductive core is surrounded by a self-healing, electrically insulative layer.

16. An illumination device according to claim 15, further comprising an auxiliary light module configured to be detachably mounted along the between the first end and the second end of one of the plurality of independent anus.

17. An illumination system, comprising:
an illumination device, comprising:
a plurality of independently poseable arms, wherein each arm has a first end and a second end and the first end is electrically connected to the second end,
a plurality of light modules, each light module being coupled and electrically connected to the first end of one of the plurality of independently poseable arms,
a housing coupled to the second end of each of the plurality of arms is connected to the housing and configured to receive a power source, and
a switch configured to control electrical connections between the second end of each of the plurality of arms and the power source such that the plurality of light modules operate in unison; and
a charging device configured to charge the power source.

18. An illumination system according to claim 17, further comprising:
a stand configured to hold the illumination device.

19. An illumination system according to claim 18, wherein the charging device is integrated with the stand.

20. An illumination device according to claim 19, wherein the stand is configured to be attachable affixed to a stationary surface.
